(19) United States
(12) Patent Application Publication
(10) Pub. No.: US 2026/0244471 A1
(43) Pub. Date: Aug. 20, 2026

(54) AGENT FOR DETECTING ACCESSIBILITY ISSUES IN WEBSITES

(71) Applicant: Evinced, Inc., Los Altos Hills, CA (US)

(72) Inventors: Yossi SYNETT, Hod Hasharon (IL); Gal MOAV, Tel Aviv (IL); Navin R. THADANI, Los Altos Hills, CA (US); Evyatar Yaakov OR, Rosh Haayin (IL); Tair HAKMAN, Katzrin (IL); Kfir Yehuda ORGIL, Zofit (IL); Avital HOFFNER BOAS, Tel Aviv (IL)

(73) Assignee: Evinced, Inc., Los Altos Hills, CA (US)

(21) Appl. No.: 19/534,116

(22) Filed: Feb. 9, 2026

Related U.S. Application Data
(60) Provisional application No. 63/760,877, filed on Feb. 20, 2025.

(51) Int. Cl. G06F 9/451; G06F 3/16; G06F 11/3668

(52) U.S. Cl. CPC G06F 9/453; G06F 3/167; G06F 11/3688

(57) ABSTRACT

The method and system for detecting accessibility issues in web pages for assistive-technology users are presented. The method includes generating a prompt for a language model integrated with a first AI agent, the prompt including a task for the first AI agent on a web page using actions configured to mimic interactions expected of an assistive-technology user; providing the prompt to the language model, wherein the language model is trained to determine a first action for the first AI agent on the web page; performing, by the first AI agent, the determined first action on the web page by interacting with a component in the user interface of the web page; receiving, by the first AI agent, an output from the assistive-technology in response to performing the determined first action; and detecting at least one accessibility issue for an assistive-technology user based on actions performed and outputs by the assistive-technology.

### CROSS-REFERENCE TO RELATED APPLICATIONS

This application claims the benefit of US Provisional Application No. 63/760,877 filed on February 20, 2025, the contents of which are hereby incorporated by reference in their entirety.

### TECHNICAL FIELD

The present disclosure relates generally to computer-implemented systems and methods for evaluating digital accessibility and, more particularly, to the use of artificial intelligence–based agents and assistive-technology emulation to detect accessibility violations in web-based user interfaces through automated navigation and task execution.

### BACKGROUND

Accessibility testing ensures that websites and software are usable by people with disabilities, particularly those who are blind or visually impaired. This testing involves verifying that the content on a website is accessible via assistive technologies like screen readers, which convert text into speech or Braille. To achieve accessibility, web developers must code websites according to certain standards and guidelines, such as the Web Content Accessibility Guidelines (WCAG). These guidelines require developers to ensure that content is navigable and usable by users with a variety of disabilities including, but not limited to, those without sight or with visual impairment. Ensuring such navigability and usability includes, but is not limited to, ensuring that all images have descriptive alternative text and ensuring compatibility with screen readers. The WCAG guidelines are built around four core principles: perceivable, operable, understandable, and robust.

The perceivable principle ensures that information and user interface components are presented in ways that users can perceive. Key guidelines (from WCAG) include “1.1.1 Non-text Content,” which requires providing text alternatives for non-text content like images and icons so that they can be accessed by screen readers; “1.3.1 Info and

Relationships,” which ensures that information that is conveyed visually is also conveyed programmatically, using semantic HTML and ARIA roles for screen readers; “1.3.2 Meaningful Sequence,” which makes sure content is in the correct reading order; “1.3.3 Sensory Characteristics,” which ensures content is not solely dependent on sensory characteristics, such as color or shape, to convey meaning; “1.3.5 Identify Input Purpose,” which requires input fields to be programmatically identified by screen readers; and “1.3.6 Identify Purpose,” which ensures UI components are clearly labeled so assistive technologies can determine their purpose.

The operable principle ensures that users can interact with the content and interface. Key guidelines (from WCAG) include “2.1.1 Keyboard,” which mandates that all functionality must be operable via a keyboard, benefiting users with screen readers; “2.1.2 No Keyboard Trap,” which ensures that users cannot get stuck in an interface element when using a keyboard; “2.4.1 Bypass Blocks,” which offers skip links for screen reader users to skip repetitive content; “2.4.2 Page Titled,” which ensures each page has a meaningful title that aids navigation; “2.4.3 Focus Order,” which ensures that the navigation order is logical, helping users using screen readers; “2.4.4 Link Purpose (In Context),” which ensures that links have clear, descriptive text; “2.4.6 Headings and Labels,” which requires clear headings and labels for better understanding; and “2.4.8 Location,” which provides navigation indicators to assist screen reader users.

The understandable principle ensures that content and interactions are clear and predictable. Key guidelines include, “3.2.1 On Focus,” which ensures that receiving focus does not trigger unexpected changes, preventing confusion for users; “3.2.2 On Input,” which prevents automatic changes when a user inputs data into a form, reducing errors; “3.2.3 Consistent Navigation,” which ensures that navigation mechanisms are consistent across the site; “3.2.4 Consistent Identification,” which ensures that components with the same function have consistent labels; “3.3.1 Error Identification,” which ensures that errors in forms are identifiable for screen readers; “3.3.2 Labels or Instructions,” which ensures forms include proper labels for assistive technologies; “3.3.3 Error Suggestion,” which provides suggestions for correcting errors in forms; and “3.3.4 Error Prevention” prevents major errors by confirming submission actions.

The robust principle focuses on creating content that can be reliably interpreted by a wide variety of user agents, including assistive technologies. Key guidelines (from WCAG) include “4.1.2 Name, Role, Value,” which ensures that UI components expose their name, role, and value to assistive technologies, providing the necessary context for users; and “4.1.3 Status Messages,” which ensures that dynamic content updates are announced by screen readers, allowing users to stay informed of changes in the content without needing to manually refresh the page.

For a website to be compliant with accessibility standards, developers must create code that supports features like semantic HTML, proper heading structures, keyboard navigability, and ARIA (Accessible Rich Internet Applications) roles and attributes. ARIA roles and attributes help to improve the accessibility of dynamic content or complex user interfaces, providing additional information to assistive technologies about the behavior and purpose of elements.

However, there are several challenges with accessibility testing. First, many legacy testing tools are not integrated into the software development flow, meaning that accessibility checks are often an afterthought, conducted at the end of the development cycle rather than as part of the continuous testing process. This delay can make fixing issues more time-consuming and costly. Second, legacy tools often require developers to check each individual issue in isolation, making it difficult to focus on fixing components. This means that developers end up tackling small, isolated issues rather than addressing the underlying structural or design problems that affect multiple areas of a website. A third problem is that testing web pages manually would require an immense amount of time and resources. Additionally, the outcomes of such testing can be subjective, depending on the person conducting the tests. This complexity increases the burden on testing teams, who would need to carefully evaluate every possible combination of roles and attributes to ensure full accessibility compliance, a task that becomes increasingly difficult as the number of components and interactions on a site grows.

It would therefore be advantageous to provide a solution that addresses the above challenges.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include generating a prompt, by a prompt engine, for a language model integrated with a first AI agent, the prompt including a task for the first AI agent to complete on a web page using actions configured to mimic interactions expected of an assistive-technology user; providing the prompt to the language model, where the language model is trained to determine a first action for the first AI agent to perform on the web page; performing, by the first AI agent, the determined first action on the web page by interacting with at least one component in the user interface of the web page; receiving, by the first AI agent, at least one first output from the assistive-technology in response to performing the determined first action on the web page; detecting at least one accessibility issue for a user of an assistive-technology based on actions performed and outputs by the assistive-technology. Other embodiments of this aspect include corresponding computer systems, apparatus, and computer programs recorded on one or more computer storage devices, each configured to perform the actions of the methods.

Implementations may include one or more of the following features. The method may include: determining, by the language model integrated with the first AI agent, at least one subsequent action based on the output from the assistive-technology; performing, by the first AI agent, the determined at least one subsequent action on the web page by interacting with at least one component in the user interface of the web page; and receiving, by the first AI agent, at least one subsequent output from the assistive-technology in response to performing the determined at least one subsequent action on the web page; when performing any action does not further the first AI agent’s completion of the task to a predetermined degree, executing an action assistance from a second AI agent to achieve the task, where the second AI agent is configured to assist the first AI agent to complete the task, where any action includes the first action and the at least one subsequent action; determining, by the first AI agent, that an action does not further the first AI agent’s completion of the task to a predetermined degree when a number of subsequent actions are continuations of a preceding action without furthering completion of the task exceeds a pre-determined threshold.

The method where the inputs include at least one of: a role description, configuration of a particular screen reader software, information about a particular user device, a starting point, a task, a log, a visual representation of the structure of a particular Web resource, a list of specific actions, instructions to use a particular navigation tool, and various execution strategies based on the task and the visual representation; allocating, by the first AI agent, control of the task to the second AI agent to execute the action assistance; updating at least one visual representation of the web page with information based on the at least one first output and the at least one subsequent output, where the visual representation of the web page includes representation of components of user interface of the web page; iteratively testing a plurality of patterns of interaction with various components of the user interface of a web page; generating, by the prompt engine, inputs to be included in the generated prompt.

The method where an accessibility issue of the accessibility issues relates to an issue with the perceivability, operability, understandability, and/or robustness of a web page for mobile-device assistive technology use.

The method where the assistive-technology is a screen-reader technology for visually-impaired users to operate web pages. Implementations of the described techniques may include hardware, a method or process, or a computer tangible medium.

In one general aspect, non-transitory computer-readable medium may include one or more instructions that, when executed by one or more processing circuitries of a device, cause the device to: generate a prompt, by a prompt engine, for a language model integrated with a first AI agent, the prompt including a task for the first AI agent to complete on a web page using actions configured to mimic interactions expected of an assistive-technology user; provide the prompt to the language model, where the language model is trained to determine a first action for the first AI agent to perform on the web page; perform, by the first AI agent, the determined first action on the web page by interacting with at least one component in the user interface of the web page; receive, by the first AI agent, at least one first output from the assistive-technology in response to performing the determined first action on the web page; and detect at least one accessibility issue for a user of an assistive-technology based on actions performed and outputs by the assistive-technology. Other embodiments of this aspect include corresponding computer systems, apparatus, and computer programs recorded on one or more computer storage devices, each configured to perform the actions of the methods.

In one general aspect, the system may include a processing circuitry. The system may also include a memory, the memory containing instructions that, when executed by the processing circuitry, configure the system to: generate a prompt, by a prompt engine, for a language model integrated with a first AI agent, the prompt including a task for the first AI agent to complete on a web page using actions configured to mimic interactions expected of an assistive-technology user; provide the prompt to the language model, where the language model is trained to determine a first action for the first AI agent to perform on the web page; perform, by the first AI agent, the determined first action on the web page by interacting with at least one component in the user interface of the web page; receive, by the first AI agent, at least one first output from the assistive-technology in response to performing the determined first action on the web page; detect at least one accessibility issue for a user of an assistive-technology based on actions performed and outputs by the assistive-technology. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: determine, by the language model integrated with the first AI agent, at least one subsequent action based on the output from the assistive-technology; perform, by the first AI agent, the determined at least one subsequent action on the web page by interacting with at least one component in the user interface of the web page; and receive, by the first AI agent, at least one subsequent output from the assistive-technology in response to performing the determined at least one subsequent action on the web page.

The system where the memory contains further instructions which when executed by the processing circuitry further configure the system to: when perform any action does not further the first AI agent’s completion of the task to a predetermined degree, executing an action assistance from a second AI agent to achieve the task, where the second AI agent is configured to assist the first AI agent to complete the task, where any action includes the first action and the at least one subsequent action.

The system where the memory contains further instructions which when executed by the processing circuitry further configure the system to: determine, by the first AI agent, that an action does not further the first AI agent’s completion of the task to a predetermined degree when a number of subsequent actions are continuations of a preceding action without furthering completion of the task exceeds a pre-determined threshold.

The system where the inputs include at least one of: a role description, configuration of a particular screen reader software, information about a particular user device, a starting point, a task, a log, a visual representation of the structure of a particular Web resource, a list of specific actions, instructions to use a particular navigation tool, and various execution strategies based on the task and the visual representation.

The system where the memory contains further instructions which when executed by the processing circuitry further configure the system to: allocate, by the first AI agent, control of the task to the second AI agent to execute the action assistance.

The system where the memory contains further instructions which when executed by the processing circuitry further configure the system to: update at least one visual representation of the web page with information based on the at least one first output and the at least one subsequent output, where the visual representation of the web page includes representation of components of user interface of the web page.

The system where the memory contains further instructions which when executed by the processing circuitry further configure the system to: iteratively test a plurality of patterns of interaction with various components of the user interface of a web page.

The system where the memory contains further instructions which when executed by the processing circuitry further configure the system to: generate, by the prompt engine, inputs to be included in the generated prompt.

The system where an accessibility issue of the accessibility issues relates to an issue with the perceivability, operability, understandability, and/or robustness of a web page for mobile-device assistive technology use.

The system where the assistive-technology is a screen-reader technology for visually-impaired users to operate web pages. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows an example network diagram utilized to describe the various disclosed embodiments.

FIG. 2 shows an example functional diagram of a blind agent designed according to one embodiment.

FIG. 3 illustrates an example flowchart of a process for navigation testing to identify accessibility issues in websites.

FIG. 4 is an example interface of the testing system according to an embodiment.

FIG. 5 is an example schematic diagram of a testing system according to an embodiment.

### DETAILED DESCRIPTION

The various disclosed embodiments include a method and system that provide agentic navigation of web pages rendered on a web browser to enable enhanced detection of accessibility compliance violations and accessibility issues in the web pages. The use of an AI-based agent offsets the responsibility from software developers having to manually test the large number of patterns of user interactions with various components on a web page. This testing is achieved more efficiently through agentic processing, using generative artificial intelligence (AI) systems, of these navigation tasks on a large number of user patterns.

The disclosed embodiments also allow for the enhanced detection of accessibility compliance violations in web pages by testing the large number of patterns of interactions a blind user may encounter when navigating the web page to achieve a particular task. Enhanced detection is also provided by the use of a Large Language Model (LLM) that is given custom prompts that, when executed by the LLM, simulates the multiple patterns of experiences of a blind user navigating a web page using a Screen Reader to achieve a variety of tasks.

The structure of a digital user interface (e.g., a Web browser, web page, or other rendered application interface) includes interface elements that are programmatically defined and exposed to user agents and assistive technologies. . As used herein, “component” refers to any interface element that users engage with to perform an action or view information such as, but not limited to, a button (to trigger an action or event within the interface), a toggle (to switch between two states or options), a radio button (to select one option from a group of mutually exclusive choices), a text field (to input data, like typing text or entering values), a heading (to define the title or category of a section), a combobox (to choose from a list of options), a checkbox (to select one or more options

from a list), a slider (to adjust a value within a defined range), a progress bar (to indicate the completion status of a process or task), a modal window ( to present additional content or actions in a temporary overlay), and a tooltip (to offer brief, contextual information about an element when users hover or focus on the element).

Additionally, the navigation testing performed by the disclosed embodiments enables detection of issues that arise from user experience failures, including violations that cannot be attributed to an isolated syntactic, programmatic, or markup defect. In such cases, the underlying syntax or code may be formally valid, yet the resulting interaction experience causes a blind or assistive-technology user to be unable to complete a task, to encounter excessive friction, to expend disproportionate effort due to the structure, sequencing, feedback, or overall behavior of the interface, and the like. These experience-level failures constitute accessibility violations, including violations of applicable accessibility guidelines such as WCAG, notwithstanding apparent compliance with individual markup rules or technical checks. The disclosed embodiments allow for detecting issues that manifest through realistic navigation and task execution by disabled users, rather than solely through static or syntactic analysis, and serve to optimize web pages for navigation by such users.

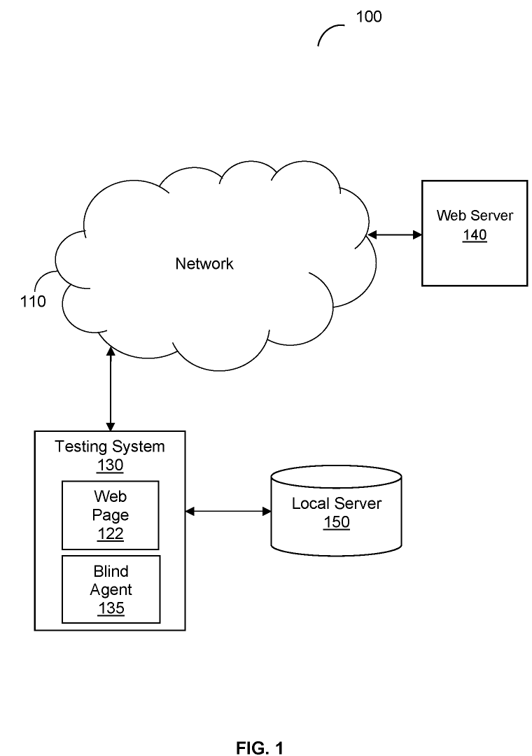

FIG. 1 shows an example network diagram 100 utilized to describe the various disclosed embodiments. In the example, a network diagram 100, a web server 140, a testing system 130, a blind agent 135, a web page 122, and a local server 150 communicate via a network 110. The network 110 may be, but is not limited to, a wireless, cellular, or wired network, a local area network (LAN), a wide area network (WAN), a metro area network (MAN), the Internet, the world wide web (WWW), similar networks, and any combination thereof.

Web server 140 stores web resources including, but not limited to, web pages. The web pages stored by the web server 140 are retrievable via a URL. The testing system 130 may, over the network 110, access a web page from the web server 140 through a URL.

The testing system 130 runs the blind agent 135 and the web page 122. In an embodiment, the testing system 130 runs the blind agent 135 on a web page 122 that the testing system 130 retrieves from the Web Server 140. The web page 122 may include a

graphical user interface (GUI) that is configured to be navigated by a blind user or visually impaired user via a Screen Reader (not shown). In an embodiment, the testing system 130 includes (and runs) an omni-agent 240 (not shown), a prompt engine 210 (not shown), and an LLM 220 (not shown).

In an alternative embodiment, the testing system 130 may retrieve a web page from a local server 150. According to this embodiment, the local server 150 may include the HTML code, CSS, JavaScript, WebAssembly, and other client-side or server-side technologies that collectively determine rendered content, behavior, and accessibility semantics of a web page. In another embodiment, results of the operations of the testing system 130 on a web page 122 may be saved and stored on the local server 150.

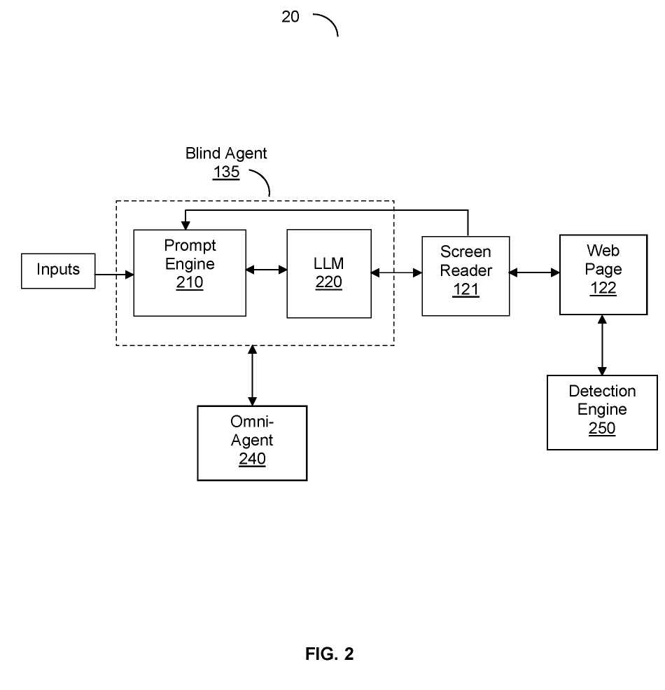

FIG. 2 shows an example functional diagram 200 of a blind agent 135 designed according to one embodiment. In some embodiments, the blind agent 135 is configured to operate web pages in a manner that emulates how a blind or visually impaired user interacts with a digital interface using assistive technology. Such interfaces may be implemented using HTML, CSS, JavaScript, WebAssembly, and other client-side or server-side technologies that collectively determine rendered content, behavior, and accessibility semantics. Screen Reader software is enabled on an operating system (OS) on which the web pages are hosted. As used herein, “screen reader,” “screen reader software” or the like refers to assistive technology that interprets accessibility information exposed by the OS, browser, and application layers and provides corresponding auditory, tactile, or other non-visual output to a user. The blind agent 135 can be realized in software, hardware, firmware, or a combination thereof. The software system comprises one or more computer-readable storage media storing instructions that, when executed by one or more processors, cause the system to perform one or more functions as described herein. The software may be implemented in various programming languages and may operate on different computing environments, including but not limited to cloud-based systems, distributed networks, standalone computing devices, or embedded systems. The software may include or invoke artificial intelligence components, including one or more large language models (LLMs), generative models, multimodal models, or other machine-learned models that perform reasoning, planning, inference, prediction, or decision-making operations based on structured or unstructured inputs. Such AI components may be locally executed, remotely hosted, or accessed via application programming interfaces (APIs), and may be fine-tuned, prompted, or otherwise configured to emulate user behavior, assistive-technology interactions, or task-oriented navigation. The software may include algorithms, machine learning models, or rule-based processing to achieve the described functionality. Various implementations may employ modular, service-oriented, or microservices architectures, and the system may interface with databases, APIs, or external services.

The example functional diagram 200 illustrates various disclosed embodiments that allow the blind agent 135 to navigate a multitude of permutations of interaction patterns with interface components in order to evaluate accessibility across a wide range of realistic user behaviors. Such navigation testing may be performed at any stage of a product lifecycle, including design, development, testing, deployment, post-deployment monitoring, or continuous operation, and is not limited to development-time testing.

Blind agent 135 includes a prompt engine 210 and LLM 220. The prompt engine 210 is configured to receive inputs and is configured to assemble structured context for the LLM 220. The LLM 220 is configured to iteratively reason about the current state of the web page, select an action that a blind or assistive-technology user would attempt, and evaluates the outcome of that action before selecting a subsequent action. Inputs to the prompt engine 210 include, but are not limited to, a role description that instructs the LLM 220 to emulate the behavior, constraints, and expectations of a blind user using assistive technology; configuration information for assistive technology or its emulation; device and platform information; a starting point; a task provided by a user or automatically generated or inferred by the system; accumulated interaction history, which may be summarized, abstracted, or otherwise managed using memory mechanisms; structural representations of the web resource; and execution strategies that govern exploration, backtracking, and termination.

In some embodiments, the task provided to the blind agent 135 is not supplied by a human user and is instead generated, inferred, or selected automatically by the testing system. In such embodiments, the system determines one or more representative or exploratory tasks for a given web page based on factors including, but not limited to, page structure, detected interface components, application domain, historical usage patterns, common user goals, or predefined accessibility testing heuristics. The automatically generated task may define a starting point, an objective, or a sequence of objectives intended to exercise realistic navigation flows that a blind or assistive-technology user is likely to attempt, thereby enabling accessibility testing even in the absence of explicit user-provided goals.

The role description of the prompt is a description of a role for the LLM 220 to emulate the perspective and behavior of a blind user relying on assistive technology to perform a task on a digital interface, including the limitations, expectations, and navigation strategies typical of such users. The role description may be, but is not limited to, “assume the role of blind user relying on assistive technology to perform on this web page.” The configuration of a particular screen reader software included in the prompt may include, but is not limited to, Job Access With Speech (JAWS), Nonvisual Desktop Access (NVDA), VoiceOver, TalkBack, Narrator, Supernova, and ZoomText. Particular information about a user device included in the prompt (e.g., user device 120) may include the operating system (OS) of the device. The OS may include but is not limited to, Windows®, iOS®, macOS®, Linux®, Android, and Chrome OS®. A starting point included in the prompt may be, but is not limited to, a URL, a DNS address, and an IP address. The task of the prompt refers to a specific problem or objective that the model is asked to solve using its capabilities. The task may include, but is not limited to, “simulate the experience of a blind user navigating a digital interface.” The log included in the prompt is a history of actions on a web page 122 by a Screen Reader 121 and responses from the Screen Reader 121 in response to the actions on the web page 122. The visual representation of the structure of a Web resource included in the prompt may be, but is not limited to, a DOM/accessibility tree representation, focus order graph, state transition graph, timeline, diagram, image, or the like. The list of specific actions included in the prompt is a list of actions to navigate and interact with user interface components on a web page 122, including, but not limited to, moving to the next heading, clicking a button, or typing text. The instructions included in the prompt include instructions on how to use a particular navigation tool such as, but not limited to, VoiceOver Rotor. The various execution strategies in the prompt are strategies to achieve the given task based on the log and the visual representation of the web page 122 as well as any other input in the prompt.

When the prompt is provided to the LLM 220, the LLM 220 is configured to generate an output that specifies one or more candidate actions intended to advance completion of the task. The blind agent 135 is configured to select and perform an action from the generated output, thereby advancing interaction with the web page 122 using assistive-technology-equivalent navigation.

For example, the blind agent 135 navigates a cursor to a menu dropdown button on the web page 122 as a determined next action. As the blind agent 135 is performing this action on the web page 122, a Screen Reader 121 is enabled and provides responses as a result of the determined next action. For example, the Screen Reader 121 may provide an auditory output through the user device 120 to a user that includes, for example, “you are on a menu button.”

In an embodiment, outputs corresponding to responses that would be produced by a screen reader are provided to the LLM 220. Such outputs may be obtained directly from an operating screen reader or may be generated by an assistive-technology emulation module that predicts screen reader announcements based on accessibility semantics, focus state, and interface context. The LLM 220 is configured to evaluate these outputs to determine whether progress toward the task is being made, whether an alternative strategy should be attempted, or whether the task should be abandoned due to non-convergence. If the determined next action is blocked (e.g., the blind agent 135 is unable to perform the actions on the web page 122), omni-agent 240 is configured to assist the blind agent 135 to perform the actions. Detection Engine 250 records the actions by the blind agent 135 on the web page 122 and the responses from the Screen Reader 121 as a result of those actions to detect accessibility issues on the web page 122.

In another embodiment, responses from the Screen Reader 121 are sent to the prompt engine 210 to update the visual representation of the web page 122. This approach allows for maintaining an evolving internal representation of the web page state based on previous interactions, enabling efficient exploration of alternative navigation paths and systematic simulation of diverse blind-user experiences.

As an example, to illustrate various disclosed embodiments, the prompt engine 210 may receive inputs and generate an initial prompt that includes a URL “https://www.soundtry.com”; a task to simulate the experience of a blind user in booking an appointment to test a particular set of headphones as a john doe any date and time; a platform configuration, such as macOS® 15.3 Sequoia with Safari 18; a record of any previous interactions with the website, which may be summarized or abstracted; a combination thereof; and the like. In an embodiment, the initial prompt is configured to cause the blind agent 135 to attempt completion of the task using interactions and feedback available through assistive-technology output alone. If the blind agent 135 fails to make progress toward the task, encounters repeated blocking conditions, or exceeds a predefined exploration threshold, the prompt engine 210 may augment or regenerate the prompt to include additional structural information about the web page, such as a visual or programmatic representation derived from an object model (e.g., a Document Object Model) that reflects the website’s data, structure, and functionality, along with revised execution strategies to advance the task. The prompt, whether initial or augmented, is provided to the LLM 220 to generate one or more actions.

The LLM 220 determines the next action as “search for controls to book an appointment.” The blind agent 135 searches, as a blind user, for controls to book an appointment and finds a first control. In response to finding the first control, the Screen Reader 121 provides an auditory response, “Open navigation menu. You are currently on a button. To click this button, press Control-Option-Space.” This response is sent to the LLM 220.

Based on a particular execution strategy, the LLM 220 determines the next action to “continue searching for controls.” The blind agent 135 searches, as a blind user, for the next controls and finds a second control. In response to finding the second control, the Screen Reader 121 provides an auditory response, “Book an appointment. You are currently on a button. To click this button, press Control-Option-Space.” This response is sent to the LLM 220.

The LLM 220 determines the next action as “activate the button to book an appointment.” The blind agent 135 activates the button. In response to activating the button, a modal window with text and calendar input fields is displayed on the website.

The LLM 220 determines the next action as “find input fields.” The blind agent 135 navigates to a heading on the website and finds no input fields. In response to the blind agent 135 navigating to a heading, the Screen Reader 121 may provide an auditory response that indicates information in the heading and the heading level. This response is sent to the LLM 220.

The LLM 220 determines the next action as “continue to look for input fields.” If, after a pre-determined number of actions are continuations of the preceding action without achieving the actions (e.g., not finding the input fields), the blind agent 135 will allocate control of the task to the omni-agent 240.

In an embodiment, the omni-agent 240, tasked with, for example, navigating to the modal window that includes the text and calendar input fields, finds the input fields and navigates to the first input field “Full Name.” Omni-agent 240 is an agent that is tasked with assisting the blind agent 135 in executing actions that the blind agent 135 is blocked or otherwise prevented from executing in furtherance of achieving the task it is prompted with. In response to the action of the omni-agent 240, the Screen Reader 121 provides an auditory response, “dialog, Full Name. Full Name is required. User information, group,” and “You are currently on a text field. To enter text into this field, type.” This response is sent to the LLM 220.

The LLM 220 determines the next action, “type alias name.” The blind agent 135 types “John Doe” into the text field for “Full Name.” The blind agent 135 continues to execute this process by inputting all necessary fields and selecting all necessary buttons, which includes receiving assistance from the omni-agent 240 when the blind agent 135 encounters errors.

Based on the navigation testing on web page 122 performed by the blind agent 135, the Detection Engine 250 is configured to detect accessibility issues in the web page 122 e.g., the “https://www.soundtry.com” URL. Accessibility issues (described herein as accessibility issues, accessibility compliance violations, accessibility violations, or the like), as discussed above, may include issues that are not in compliance with the perceivable, operable, understandable, and robust principles.

In an embodiment, the LLM 220 is executed by a generative AI (genAI) system integrated into testing system 130, as discussed below. In one embodiment, the genAI system may be located outside of testing system 130 and could be operated by a remote server (not shown).

In an embodiment, the detection engine 250 can run a script either in the web browser or as a component of the operating system (OS) that hosts the web browser.

It should be noted that, in some embodiments, an assistive-technology user operates on a mobile device executing a mobile screen reader (e.g., VoiceOver or TalkBack) and a mobile browser or native application, and the navigation testing performed by the disclosed system is configured to account for mobile-specific interaction primitives and focus behavior. For example, an AI agent may generate and apply navigation actions comprising swipe-based next/previous navigation, rotor-based traversal (e.g., by headings, landmarks, form controls), touch exploration, activation gestures, and virtual-cursor focus movement that is mediated by an accessibility API rather than a pointer device. The system may detect a non-furthering completion condition on mobile when repeated swipes or rotor traversals cycle among a limited subset of elements, when focus becomes trapped within a modal, drawer, or web-view region, when a required input is not discoverable through the mobile accessibility tree, or when an announcement indicates an error state without enabling corrective action. In response, another AI agent may provide action assistance by issuing mobile-specific corrective actions, such as programmatically moving accessibility focus to a required input, expanding a collapsed region, dismissing an obstructing overlay, invoking an alternative navigation mode, or selecting a specific control identified via the accessibility tree, DOM, or UI automation layer, thereby enabling completion of the task by the mobile-device assistive-technology user.

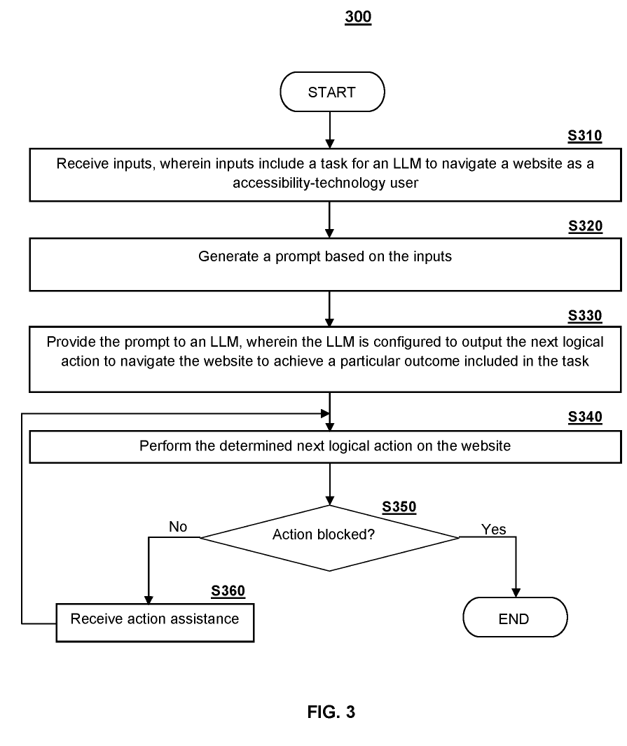

FIG. 3 illustrates an example flowchart 300 of a process for navigation testing to identify accessibility issues in websites. In an embodiment, navigation testing is performed by the blind agent 135. In another embodiment, the navigation testing is performed by the blind agent 135 and the omni-agent 240.

The flowchart 300 illustrates various disclosed embodiments that allow the blind agent 135 to navigate a multitude of permutations of patterns of interactions with components on the user interface to achieve various tasks as a blind user navigating a web page to achieve those tasks.

At S310, inputs are received. Inputs may include a task for an LLM to navigate a website as a blind user and to improve the accessibility of the website. In an embodiment, multiple tasks are received over many iterations to ensure that a sufficient number and variety of tasks (as well as navigation patterns to achieve those tasks) are tested, uncovering any accessibility issues. In an embodiment, the inputs received include the inputs discussed in detail with respect to FIG. 2.

At S320, a prompt is generated based on the inputs. In an embodiment, the prompt includes at least the inputs and a prompt template. The prompt template may be a custom prompt template pre-configured with placeholders for each of the inputs. In an embodiment, the prompt template is configured to be executed by an LLM. In an embodiment, the prompt is generated by the prompt engine 210, FIG. 2.

At S330, the generated prompt is provided to an LLM. The LLM is configured to generate an output that identifies one or more next actions that a blind user or an assistive-technology user would perform to advance toward completion of the task. In an embodiment, the blind agent 135 includes the prompt engine 210 and the LLM 220 (FIG. 2).

At S340, the determined next logical action is performed on the web page. In an embodiment, the web page is operated according to the determined next logical action. According to this embodiment, the web page is navigated using a Screen Reader software and receives responses from the Screen Reader as a result of performing the determined next logical action.

At S350, it is determined whether the task is complete. In an embodiment, the task may be the task included in the prompt executed by the LLM 220. In one embodiment, the task is determined to not be complete if actions determined by the blind agent 135 do not result in a desired outcome of that action in a pre-determined number of attempts. If it is determined that the task is complete, execution ends. If it is determined that the task is not complete, execution proceeds with S360.

At S360, action assistance is invoked. In an embodiment, action assistance is assistance to achieve the determined action on the web page to complete the task. In an embodiment, assistance is performed by the omni-agent 240.

In a further embodiment, the next logical actions may continue to be determined and performed until the task included in the prompt is achieved. In some embodiments, when performing any action does not further the first AI agent’s completion of the task to a predetermined degree, action assistance is invoked. Predetermined degree as used herein refers to a configurable threshold for measurable task progress used to determine whether an action meaningfully furthers completion of the task. For example, such a threshold may be reaching a new interface state, advancing focus to a new actionable control relevant to the task, completing an additional required field, or otherwise reducing the remaining steps to completion. In some embodiments, predetermined degree is met when a number of subsequent actions are continuations of a preceding action without furthering completion of the task exceeds a pre-determined threshold.

Although FIG. 3 shows example blocks of flowchart 300, in some implementations, flowchart 300 may include additional blocks, fewer blocks, different blocks, or differently arranged blocks than those depicted in FIG. 3. Additionally, or alternatively, two or more of the blocks of flowchart 300 may be performed in parallel.

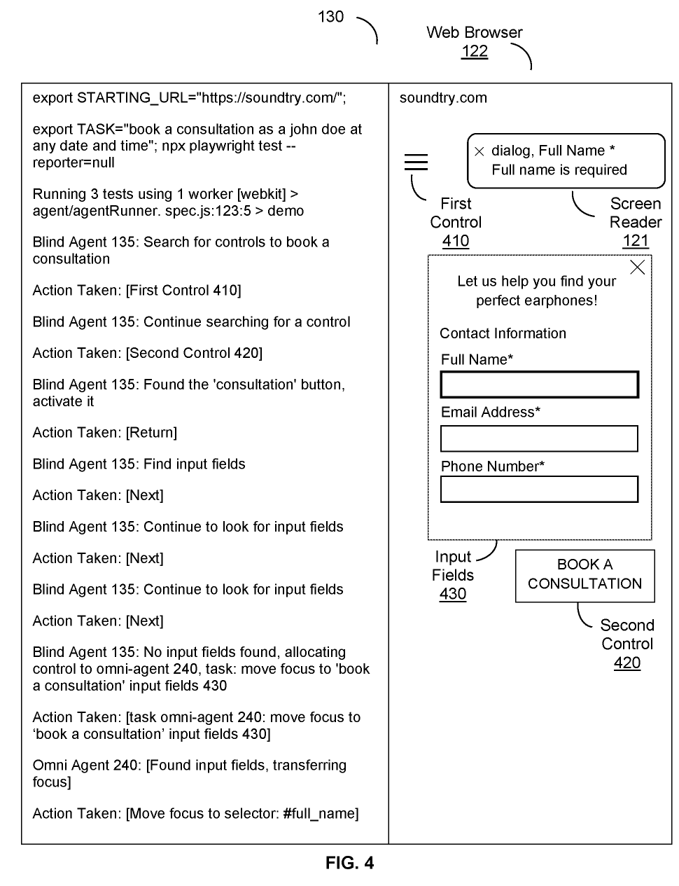

FIG. 4 is an example interface of the testing system 130 according to an embodiment. The testing system 130 includes the operations of the blind agent 135 and omni-agent 240 as well as the components of the web page 122 with a Screen Reader 121 enabled. The operations of the testing system 130 illustrated in FIG. 4 are discussed in detail with respect to FIG. 2. As explained with respect to FIG. 2, as the operations are performed on the web page 122, the Screen Reader 121 is operable and responsive to actions on the web page 122.

The starting URL, as explained above, is soundtry.com. The testing system 130 is given this URL along with the task “book a consultation as a John Doe at any date and time.” Controls to book a consultation are searched for. In an embodiment, this search is performed by the blind agent 135. The first control 410 is found. First control 410 is a menu button. In an embodiment, the search for the controls to book a consultation continues. The second control 420 is found. The second control 420 is a “book a consultation” button. This button is activated.

The next action is determined to be “find input fields.” The search for input fields continues, for example, by the blind agent 135. When no input fields are found in a pre- determined number of iterations, the omni-agent 240 is called to move focus “book a consultation” input fields (e.g., input fields 430). Input fields 430 are found and the focus of the navigation is transferred to the input fields 430. The focus is moved to the selector “Full Name.” In response to the focus being moved to “Full Name,” the Screen Reader 121 responds, “dialog, Full Name * Full Name is required.”

FIG. 4 is merely an illustrative example of an interface of the testing system 130 and should not be construed to limit the disclosed embodiments.

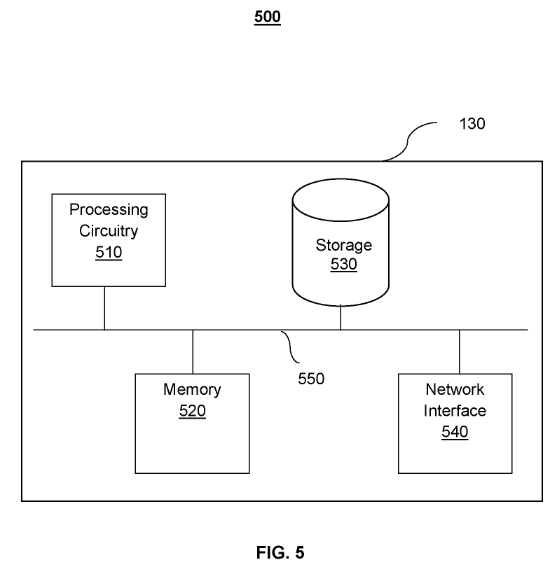

FIG. 5 is an example schematic diagram of a testing system 130 according to an embodiment. The testing system 130 includes a processing circuitry 510 coupled to a memory 520, a storage 530, and a network interface 540. In an embodiment, the components of the testing system 130 may be communicatively connected via a bus 550.

In an embodiment, the testing system 130 runs the blind agent 135 and omni-agent 240. According to this embodiment, the processing circuitry 510 is configured to execute generative artificial intelligence (genAI) models, perform inference using or otherwise apply genAI models, train genAI models, fine-tune genAI models, combinations thereof, and the like. Such genAI models are configured to produce text, images, videos, or other forms of data, and may include, but are not limited to, language models (for example, but not limited to, large language models, small language models, etc.), text-to-image artificial intelligence (AI) image generation systems, text-to-video AI video generators, combinations thereof, and the like. To this end, the processing circuitry 510 may be adapted to realize a transformer deep learning architecture (e.g., a generative pre-trained transformer [GPT], bidirectional encoder representations from transformers [BERT], text-to-text transfer transformer [T5], etc.), a diffusion model, both, and the like.

In accordance with various such embodiments, the hardware utilized for the processing circuitry 510 is selected in order to enable genAI functionality based on factors such as, but not limited to, parallelism (e.g., amounts of parallel processing to be performed), memory demands (e.g., amounts of random access memory [RAM] utilized to store model weights and training during processing or video RAM [VRAM] to support large language models), clock speeds, thread counts, storage (for example, to support certain amounts of storage or storage speeds), cooling (e.g., liquid cooling or air cooling systems), power supply (e.g., in order to enable a target wattage used for certain kinds

of activities), networking and connectivity (e.g., in order to support seamless data transfer for deployments involving communications between or among multiple machines or clusters), combinations thereof, and the like.

In embodiments that utilize large language models (LLMs) or otherwise perform operations that may require or be enhanced through the use of parallel processing, the processing circuitry 510 may include one or more GPUs or other processing units suitable for parallel processing. Such GPUs may be configured to perform matrix multiplication operations including, but not limited to, performing dot product operations in order to support neural network operations (for example, by performing dot product operations for hidden layer computations) or performing dot product operations in an attention mechanism in order to compute a similarity score between vectors during attention weight computation. In at least some such embodiments using GPUs, the processing circuitry 510 may include a number of CPU cores that is equal to or greater than the number of GPUs in order to facilitate or otherwise support parallel processing via multiple GPUs.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read-only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 540 allows the testing system 130 to communicate with, for example, the Web Server 140, and the like.

It should be understood that the embodiments described herein are not limited to the specific architecture illustrated in FIG. 5, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like

What is claimed is:

1. A method for detecting accessibility issues in web pages for assistive-technology users, comprising:
generating a prompt, by a prompt engine, for a language model integrated with a first artificial intelligence (AI) agent, the prompt including a task for the first AI agent to complete on a web page using actions configured to mimic interactions expected of a user of an assistive-technology;
providing the prompt to the language model, wherein the language model is trained to determine a first action for the first AI agent to perform on the web page;
performing, by the first AI agent, the determined first action on the web page by interacting with at least one component in the user interface of the web page;
receiving, by the first AI agent, at least one first output from the assistive-technology in response to performing the determined first action on the web page; and
detecting at least one accessibility issue for a user of an assistive-technology based on actions performed and outputs by the assistive-technology.

2. The method of claim 1, further comprising:
determining, by the language model integrated with the first AI agent, at least one subsequent action based on the output from the assistive-technology;
performing, by the first AI agent, the determined at least one subsequent action on the web page by interacting with at least one component in the user interface of the web page; and
receiving, by the first AI agent, at least one subsequent output from the assistive-technology in response to performing the determined at least one subsequent action on the web page.

3. The method of claim 2, further comprising:
when performing any action does not further the first AI agent’s completion of the task to a predetermined degree, invoking an action assistance from a second AI agent to achieve the task, wherein the second AI agent is configured to assist the first AI agent to complete the task, wherein any action includes the first action and the at least one subsequent action.

4. The method of claim 3, further comprising:
determining, by the first AI agent, that an action does not further the first AI agent’s completion of the task to a predetermined degree when a number of subsequent actions are continuations of a preceding action without furthering completion of the task exceeds a pre-determined threshold.

5. The method of claim 3, further comprising:
allocating, by the first AI agent, control of the task to the second AI agent to invoke the action assistance.

6. The method of claim 2, further comprising:
updating at least one visual representation of the web page with information based on the at least one first output and the at least one subsequent output, wherein the visual representation of the web page includes representation of components of the user interface of the web page.

7. The method of claim 1, further comprising:
generating, by the prompt engine, inputs to be included in the generated prompt.

8. The method of claim 7, wherein the inputs include at least one of: a role description, configuration of a particular screen reader software, information about a particular user device, a starting point, a task, a log, a visual representation of the structure of a particular Web resource, a list of specific actions, instructions to use a particular navigation tool, and various execution strategies based on the task and the visual representation.

9. The method of claim 2, further comprising:
iteratively testing a plurality of patterns of interaction with various components of the user interface of the web page.

10. The method of claim 1, wherein an accessibility issue of the accessibility issues relates to an issue with the perceivability, operability, understandability, and/or robustness of a web page for mobile-device assistive technology use.

11. The method of claim 1, wherein the assistive-technology is a screen-reader technology for visually-impaired users to operate web pages.

12. A non-transitory computer-readable medium storing a set of instructions for detecting accessibility issues in web pages for assistive-technology users, the set of instructions comprising:
one or more instructions that, when executed by one or more processing circuitries of a device, cause the device to:
generate a prompt, by a prompt engine, for a language model integrated with a first artificial intelligence (AI) agent, the prompt including a task for the first AI agent to complete on a web page using actions configured to mimic interactions expected of a user of an assistive-technology;
provide the prompt to the language model, wherein the language model is trained to determine a first action for the first AI agent to perform on the web page;
perform, by the first AI agent, the determined first action on the web page by interacting with at least one component in the user interface of the web page;
receive, by the first AI agent, at least one first output from the assistive-technology in response to performing the determined first action on the web page; and
detect at least one accessibility issue for a user of an assistive-technology based on actions performed and outputs by the assistive-technology.

13. A system for detecting accessibility issues in web pages for users of an assistive-technology, comprising:
a processing circuitry;
a memory, the memory containing instructions that, when executed by the processing circuitry, configure the system to:
generate a prompt, by a prompt engine, for a language model integrated with a first artificial intelligence (AI) agent, the prompt including a task for the first AI agent to complete on a web page using actions configured to mimic interactions expected of a user of an assistive-technology;
provide the prompt to the language model, wherein the language model is trained to determine a first action for the first AI agent to perform on the web page;
perform, by the first AI agent, the determined first action on the web page by interacting with at least one component in the user interface of the web page;
receive, by the first AI agent, at least one first output from the assistive-technology in response to performing the determined first action on the web page; and
detect at least one accessibility issue for a user of an assistive-technology based on actions performed and outputs by the assistive-technology.

14. The system of claim 13, wherein the memory contains further instructions which when executed by the processing circuitry further configure the system to:
determine, by the language model integrated with the first AI agent, at least one subsequent action based on the output from the assistive-technology;
perform, by the first AI agent, the determined at least one subsequent action on the web page by interacting with at least one component in the user interface of the web page; and
receive, by the first AI agent, at least one subsequent output from the assistive-technology in response to performing the determined at least one subsequent action on the web page.

15. The system of claim 14, wherein the memory contains further instructions which when executed by the processing circuitry further configure the system to:
when performance of any action does not further the first AI agent’s completion of the task to a predetermined degree, invoke an action assistance from a second AI agent to achieve the task, wherein the second AI agent is configured to assist the first AI agent to complete the task, wherein any action includes the first action and the at least one subsequent action.

16. The system of claim 15, wherein the memory contains further instructions which when executed by the processing circuitry further configure the system to:
determine, by the first AI agent, that an action does not further the first AI agent’s completion of the task to a predetermined degree when a number of subsequent actions are continuations of a preceding action without furthering completion of the task exceeds a pre-determined threshold.

17. The system of claim 15, wherein the memory contains further instructions which when executed by the processing circuitry further configure the system to:
allocate, by the first AI agent, control of the task to the second AI agent to invoke the action assistance.

18. The system of claim 14, wherein the memory contains further instructions which when executed by the processing circuitry further configure the system to:
update at least one visual representation of the web page with information based on the at least one first output and the at least one subsequent output, wherein the visual representation of the web page includes representation of components of the user interface of the web page.

19. The system of claim 13, wherein the memory contains further instructions which when executed by the processing circuitry further configure the system to:
generate, by the prompt engine, inputs to be included in the generated prompt.

20. The system of claim 19, wherein the inputs include at least one of:
a role description, configuration of a particular screen reader software, information about a particular user device, a starting point, a task, a log, a visual representation of the structure of a particular Web resource, a list of specific actions, instructions to use a particular navigation tool, and various execution strategies based on the task and the visual representation.

21. The system of claim 14, wherein the memory contains further instructions which when executed by the processing circuitry further configure the system to:
iteratively test a plurality of patterns of interaction with various components of the user interface of a web page.

22. The system of claim 13, wherein an accessibility issue of the accessibility issues relates to an issue with the perceivability, operability, understandability, and/or robustness of a web page for mobile-device assistive technology use.

23. The system of claim 13, wherein the assistive-technology is a screen-reader technology for visually-impaired users to operate web pages.
